(19) United States
(12) Patent Application Publication
(10) Pub. No.: US 2016/0202672 A1
(43) Pub. Date: Jul. 14, 2016

(54) THING COOPERATION SERVICE SYSTEM AND METHOD, AND MODELING TOOL THEREOF

(71) Applicant: Electronics and Telecommunications Research Institute, Daejeon (KR)

(72) Inventors: Noh Sam PARK, Daejeon (KR); Hoon Ki LEE, Daejeon (KR); Jong Hyun JANG, Daejeon (KR)

(21) Appl. No.: 14/930,812

(22) Filed: Nov. 3, 2015

(30) Foreign Application Priority Data
Jan. 13, 2015 (KR) 10-2015-0006015

(51) Int. Cl. G05B 13/04

(52) U.S. Cl. CPC G05B 13/04

(57) ABSTRACT

A thing cooperation service system and method, and a modeling tool thereof are provided. The thing cooperation service system includes a storage manager configured to store and manage a thing control specification with respect to a plurality of things; and a modeling tool configured to provide the user with a thing which is in a specific social relationship with a user in the plurality of things using information of the user and the thing control specification, and generate an application providing a thing cooperation service using a thing selected from things which are in the specific social relationship.

### CROSS-REFERENCE TO RELATED APPLICATION

This application claims priority to and the benefit of Korean Patent Application No. 10-2015-0006015, filed on Jan. 13, 2015, the disclosure of which is incorporated herein by reference in its entirety.

### BACKGROUND

1. Field of the Invention

The present invention relates to thing cooperation service technology, and more particularly, to a thing cooperation service system and method through the Internet of things, and a modeling tool thereof.

2. Discussion of Related Art

In these days, users want to share information in various information terminals such as a television (TV) or a computer with acquaintances. Generally, information sharing between terminals has been performed by local area communication, an e-mail, a text message, a data transmission and reception program, etc.

Recently, technology sharing a thing of one person with another person is being developed using the Internet of things (IoT). The IoT is estimated as technology accelerating a smart environment between a thing and a person.

Further, Web of things (WoT) technology is technology related to an application and a service which can be driven on the IoT through Web technology, and utilization thereof can be increased by applying advantages of the Web to a concept of the IoT.

### SUMMARY OF THE INVENTION

The present invention is directed to a thing cooperation service system and method which can provide a Web of things (WoT)-based thing cooperation service, and a modeling tool thereof.

The above and other objects, features and advantages of the present invention will become more apparent to those of ordinary skill in the art by describing in detail exemplary embodiments thereof with reference to the accompanying drawings.

According to one aspect of the present invention, there is provided a thing cooperation service system including: a storage manager configured to store and manage a thing control specification with respect to a plurality of things; and a modeling tool configured to provide the user with a thing which is in a specific social relationship with a user in the plurality of things using information of the user and the thing control specification, and generate an application providing a thing cooperation service using a thing selected from things which are in the specific social relationship.

Here, the user may use the thing cooperation service by connecting to the modeling tool through a mobile terminal, or the user may manipulate an input and output interface of a computer in which the modeling tool is installed, and use the modeling tool.

At this time, the storage manager may search for a thing which is in the specific social relationship with the user among the plurality of things using information with respect to the specific social relationship among pieces of information of the user, and provide the found thing to the modeling tool.

The modeling tool may provide a graphic interface capable of inputting a control condition and a rule of the selected thing, and generate a rule file including a control condition and a control rule of the selected thing according to an input of the user through the graphic interface.

Further, the modeling tool may store a Java source code template for each execution pattern, receives a setting value of the Java source code template corresponding to the execution pattern input from the user, and generate the application.

Moreover, the modeling tool may generate a method file and a representational state transfer (REST) application program interface (API) call code with respect to the selected thing performing access when executing the application using the thing control specification.

According to another aspect of the present invention, there is provided a modeling tool for a thing cooperation service including: a rule modeler configured to provide a graphic interface capable of receiving thing selection, a thing function, and a thing control condition, and generate a rule file based on an input of the graphic interface by a user; and a rule executor configured to execute an application for a Web of things (WoT) service at a time according to the rule file using a thing control specification and the rule file of a thing selected through the graphic interface.

Here, the rule modeler may receive a plurality of thing lists which are in a specific social relationship with the user and a thing control specification from a thing storage unit using information input by the user, and receive the thing selection, the thing function, and the thing control condition with respect to at least one thing in the plurality of thing lists through the graphic interface.

Further, the rule modeler may verify semantics of a control rule with respect to a thing selected through the graphic interface in the process of making the rule file or when ending the making of the rule file, and provide information on whether the control rule is erroneous.

The rule modeler may generate a Java skeleton file using the thing control specification of the selected thing, confirm a result according to input and output parameters and a type when executing the control rule using the Java skeleton file without a Web call with respect to the selected thing, and verify whether the control rule is erroneous.

Meanwhile, the rule executor may store a template for each execution pattern of the application for the WoT service, receive a setting value of the template for each execution pattern input by the user, and generate a Java byte code for the WoT service using the setting value.

Further, the rule executor may access the selected thing at a time according to the rule file, and execute the application using a byte code for the WoT service

Moreover, the rule executor may generate a basic Java source code with respect to the selected thing from the thing control specification of the selected thing, generate a Java source code for the WoT service using the generated basic Java source code and the template for each execution pattern in which the setting value is input, and generate the Java byte code for the WoT service by compiling the Java source code for the WoT service.

In an embodiment, the rule executor may end the application at a time set according to the rule file.

According to still another aspect of the present invention, there is provided a thing cooperation service method of a modeling tool, including: receiving a thing list which is in a social relationship with a user, and a thing control specification; receiving a selected thing in the thing list, a control condition, and a control rule through a graphic interface; generating a rule file controlling the selected thing based on the rule input through the graphic interface; and generating an application for a WoT service using the rule file.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a diagram illustrating a thing cooperation service system according to an embodiment of the present invention;

FIG. 2 is a diagram illustrating a kind of things according to an embodiment of the present invention;

FIG. 3 is a diagram illustrating an example of information with respect to a thing according to an embodiment of the present invention;

FIG. 4A is a diagram illustrating a rule modeler according to an embodiment of the present invention;

FIG. 4B is a diagram illustrating a rule executor according to an embodiment of the present invention;

FIGS. 5A to 5D are diagrams illustrating a graphic interface according to an embodiment of the present invention;

FIG. 6 is a flowchart for describing a method of using a thing cooperation service according to an embodiment of the present invention; and

FIG. 7 is a diagram illustrating a rule file according to an embodiment of the present invention.

### DETAILED DESCRIPTION OF EXEMPLARY EMBODIMENTS

The above and other objects, features and advantages of the present invention will become more apparent to those of ordinary skill in the art by describing in detail exemplary embodiments thereof with reference to the accompanying drawings. However, the present invention is not limited to exemplary embodiments which will be described hereinafter, and can be implemented by various different types. Exemplary embodiments of the present invention are described below in sufficient detail to enable those of ordinary skill in the art to embody and practice the present invention. The present invention is defined by claims. Meanwhile, the terminology used herein to describe exemplary embodiments of the invention is not intended to limit the scope of the invention. The articles “a,” “an,” and “the” are singular in that they have a single referent, but the use of the singular form in the present document should not preclude the presence of more than one referent. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof.

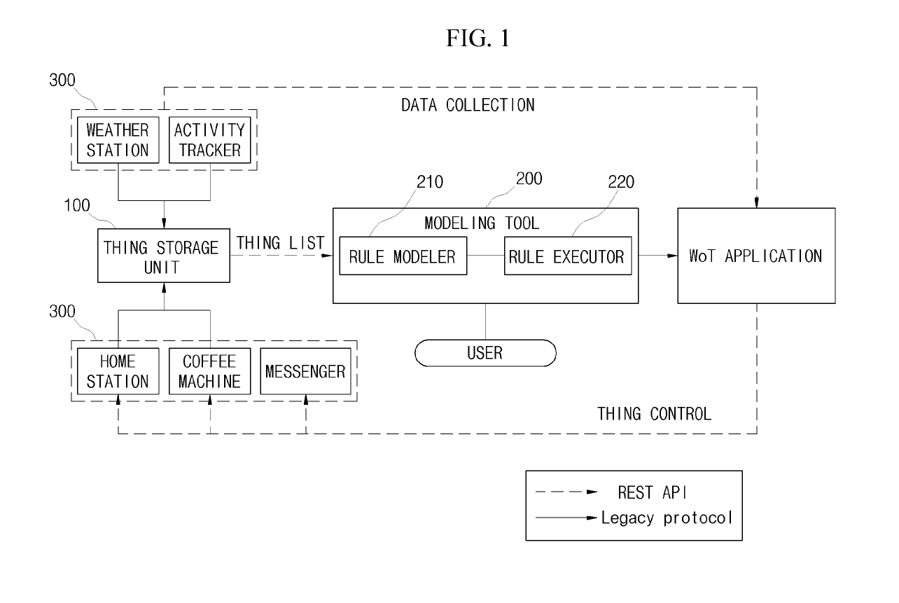

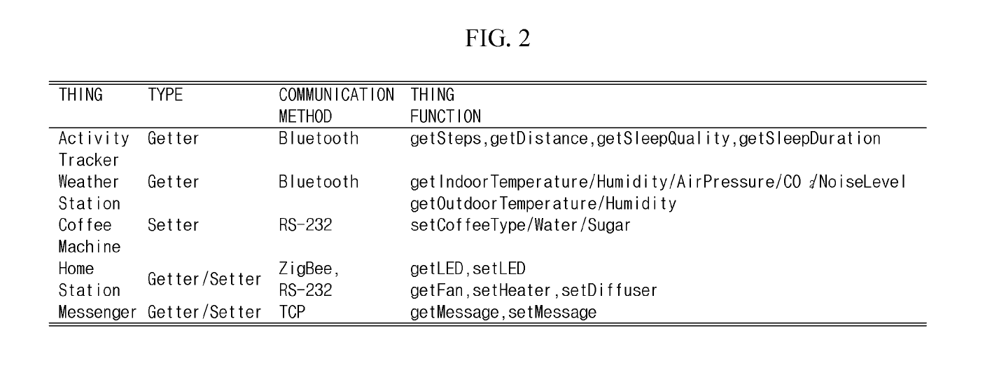

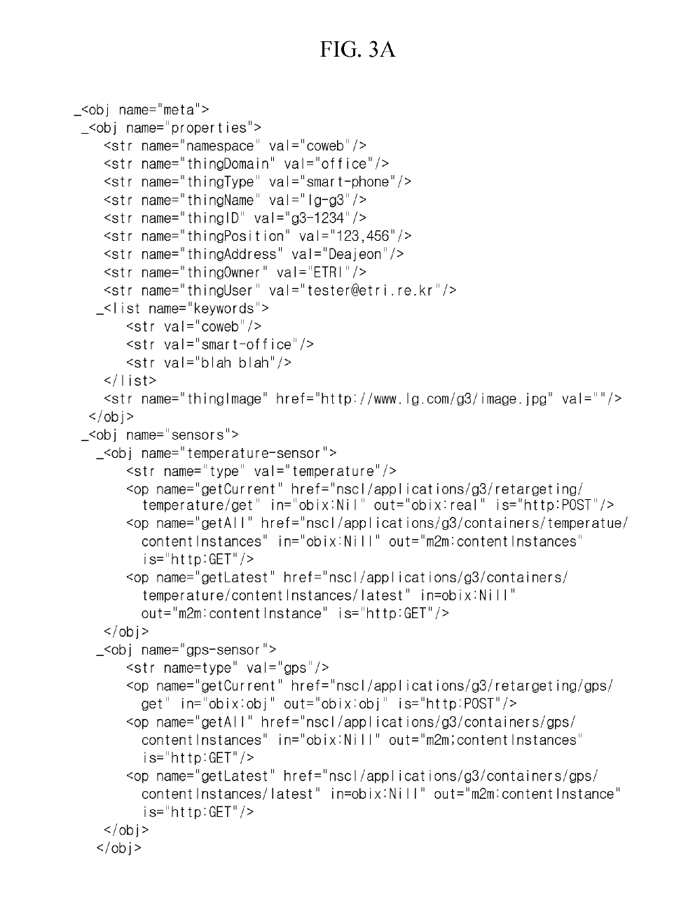

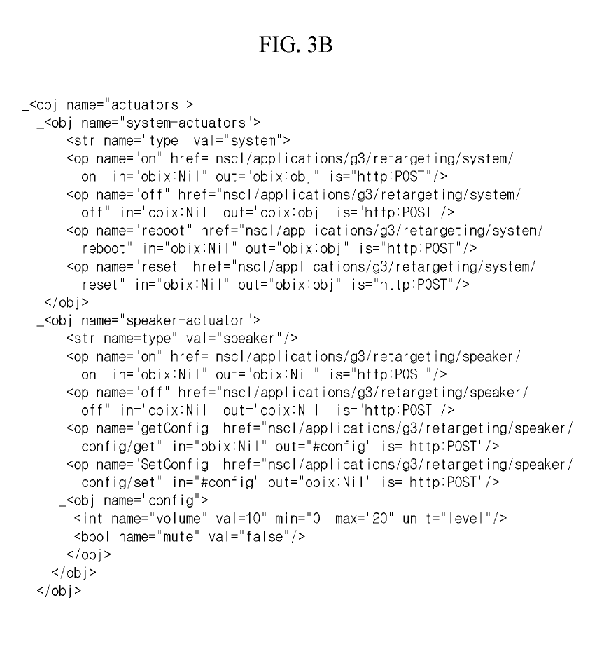

Hereinafter, embodiments of the present invention will be described in detail with reference to the accompanying drawings. FIG. 1 is a diagram illustrating a thing cooperation service system according to an embodiment of the present invention, FIG. 2 is a diagram illustrating a kind of things according to an embodiment of the present invention, and FIG. 3 is a diagram illustrating an example of information with respect to a thing according to an embodiment of the present invention.

As shown in FIG. 1, the thing cooperation service system according to an embodiment of the present invention may include a plurality of things 300, a thing storage unit 100, and a modeling tool 200.

The plurality of things 300 may be devices allowing a Web access of a type of a Web service using a representational state transfer (REST) application programming interface (API) for a Web of things (WoT) service.

For example, the plurality of things 300 may be various sensors such as an activity tracker, a weather station, a coffee machine, a home station, etc., and be virtual devices such as an e-mail, a messenger, etc.

Each thing 300 may be possessed by a specific user or group, and be in a social relationship with each user according to a setting of relation between users. For example, when a user A which is in a friend relation on a social network service (SNS) allows a user B to access a thing which is possessed by the user A, the thing of the user A may be in a social relationship with the user B since the thing of the user A can be accessed by the user B. Here, the social network may be formed by the user which desires to share things. For example, the user sharing the things may form the social network of each thing by inputting a user range capable of sharing the things when registering the things.

As shown in FIG. 2, things 300 may be classified into a getter (only for information reception), a setter (only for thing control), or a getter/setter (for both reception and control) according to its shape.

For example, since a weather station can only transmit a temperature and humidity information (getIndoorTemperature, getIndoorHumidity) but cannot control, the weather station may be the getter, and since a coffee machine can only select a kind of coffees/an amount of water/an amount of sugar and control to make coffee but cannot receive information such as a status, etc., the coffee machine may be a setter. A function of each thing shown in FIG. 2 will be described below.

The activity tracker may be a device measuring at least one among the number of walking paces, a walking distance, sleep quality, and a sleeping time. Further, the weather station may be a device measuring environment information such as an indoor and outdoor temperature, humidity, pressure, CO₂, noise, etc. The coffee machine may be a device making the coffee according to the kind of coffees, the amount of water, the amount of sugar, and the home station may be a device controlling a light emitting diode (LED), an electric fan, a heater, etc. connected thereto according to a user's instruction.

Meanwhile, the things 300 may be a virtual thing such as a messenger. The messenger may be a thing on the Internet which does not exist physically, but support a REST API. In this invention, the thing on the Internet may be regarded as a thing, and be used for control or information collection.

The thing storage unit 100 may be connected to the plurality of things through various protocols such as Bluetooth, Zigbee, RS-232/485, Wi-Fi, etc., collect information with respect to the plurality of things, and collect the information. At this time, the thing storage unit 100 may access each thing using a protocol corresponding to the things at a predetermined time (for example, periodically) after firstly collecting a thing control specification with respect to the plurality of things, and collect and update the thing control specification. As such, the thing storage unit 100 may maintain information with respect to the thing as the latest state.

For example, as shown in FIG. 3, the thing control specification may include a thing attribute specification and a thing function specification, and be stored in an extensible mark-up language (XML) format.

The thing attribute specification may include at least one among a type, a name, an identifier, an owner of a thing. The thing attribute specification may be used for generating a class file and a logic control code corresponding to a thing of the modeling tool 200. For example, the name of the thing may be a class name, and the identifier of the thing may be individualized as an object name. Further, the owner information may be used when the thing and each user collects the social network and when the thing storage unit 100 searches for a thing which is in the social relationship with each user.

The thing function specification may be largely classified into specification regarding a sensor and specification regarding an actuator, be interface information with respect to information provided by the thing or a control command, and include at least one among a function name (op name), a Web service unique resource identifier (URI) (for example, href), input and output parameters (in, out), and method call types (GET, POST, PUT, DELETE, is). The thing function specification may be used for generating the method file and the REST API call code of the modeling tool 200.

Meanwhile, the thing storage unit 100 may further provide a search function, in this case, receive a search keyword from the modeling tool 200, search for the thing control specification corresponding to the search keyword, and transmit the search result to the modeling tool 200. Here, the search keyword may be network information between a user which desires to search for and a tool which is in the social relationship with the user.

The thing storage unit 100 may be connected to tools 300 using various communication protocols such as Bluetooth, ZigBee, RS-232/485, Wi-Fi, etc.

Further, communication between the tools 300 and the thing storage unit 100 may conform to a one machine to machine (oneM2M) standard rule, but is not limited thereto.

The modeling tool 200 may be a personal computer (PC) in which an input and output interface is manipulated and used by the user or a central processing unit in the PC, and when providing a Web interface, etc. and the user connects in a remote area using a mobile terminal, may be a device providing a cooperation service between things. In the former case, the user which desires to use a thing cooperation service may install a program for generating a user customized thing cooperation service on his computer. Further, the function described above may be used by executing a WoT application in his computer using a processor (the modeling tool) of his computer through the interface through the installed program. Meanwhile, in the latter case, the user may use the user customized thing cooperation service using the modeling tool and the application of the modeling tool 200 which is located in a remote area through the Web interface of the REST API, etc. which is installed on his mobile terminal.

The modeling tool 200 according to an embodiment of the present invention may include a rule modeler 210 and a rule executor 220. Hereinafter, each unit of the modeling tool according to an embodiment of the present invention will be described.

The rule modeler 210 may provide a thing list which is in the social relationship with the user and information related to each thing by requesting the thing storage unit 100 according to a request of the user. In other words, the user may select a thing in which the user uses by checking the thing list which is in the social relationship with the user in the thing storage unit 100 through the rule modeler 210.

For example, the rule modeler 210 may transmit network information including information of users which are in the social relationship with the user to the thing storage unit 100 using user information of one user. And then, the thing storage unit 100 may search for a thing which is identical to information of the users included in the network information among things stored and managed in the thing storage unit 100 by referring to the network information, and transmit the thing list and the thing control specification. At this time, the user may input or select the network specification related to a thing which the user desires among the things which are in the social relationship, or the user may input or select the network information which can request only things which are in a specific social relationship.

The rule modeler 210 may provide the user with a graphic interface (GUI) generating a rule for controlling a thing. As such, in the present invention, only the thing which is in the social relationship can be controlled to be accessed in order to protect privacy and prevent a security breach.

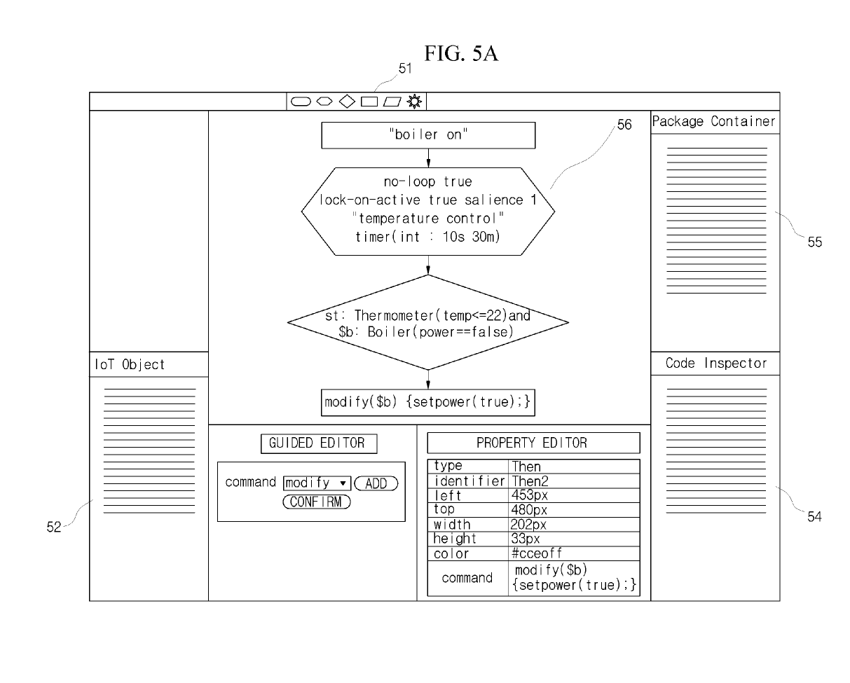

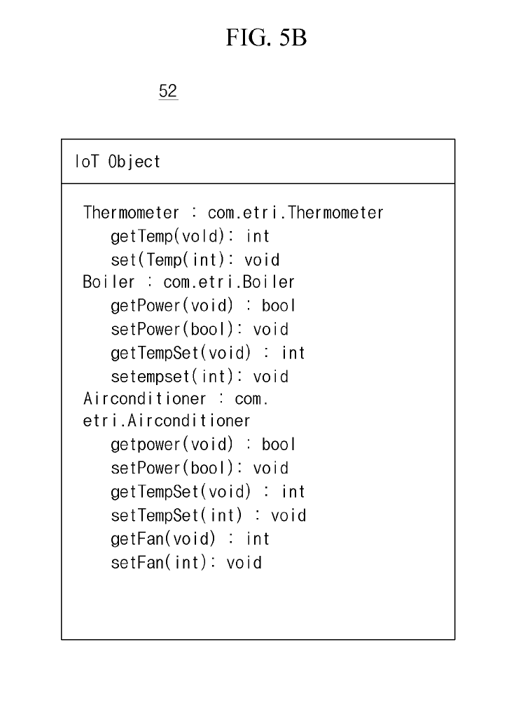

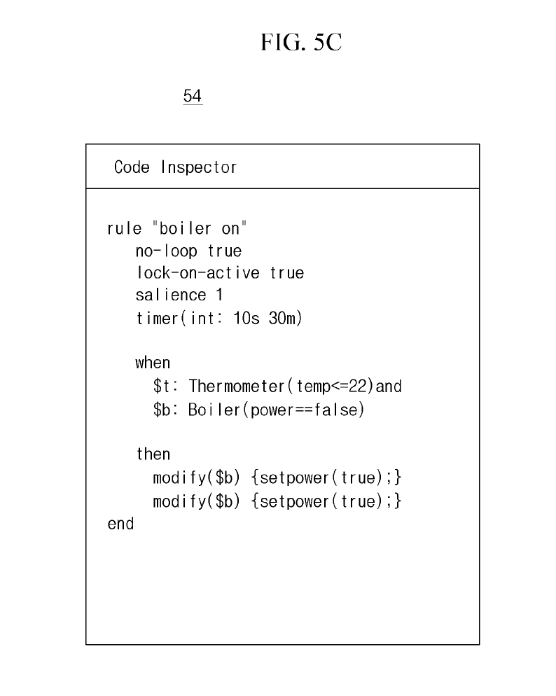

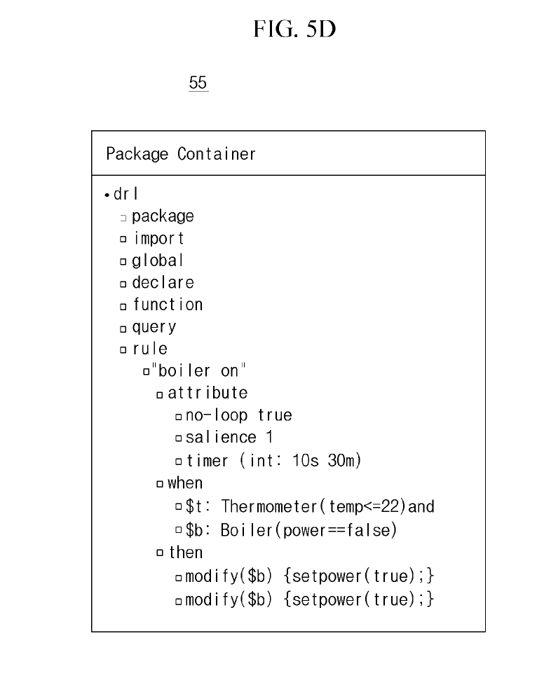

The user may confirm a function of a thing with respect to the selected thing, and generate a workflow by combining functions of a thing which desires to perform control through the graphic interface. A detailed application example of the graphic interface will be described with reference to FIGS. 5A to 5D hereinafter.

For example, when a living room temperature of a parent's house is equal to or more than 30 degrees Celsius, the user may want to control each thing to operate during one hour by setting a target temperature of an air conditioner of the living room as 25 degrees Celsius. In this case, after the user confirms whether to be in the social relationship with a thing of the parent's house (a home station and a living room air conditioner), when which is the social relationship is formed, a rule of a type controlling the home station providing temperature information and the living room air conditioner which is a cooling control device may be generated. At this time, when no the social relationship is formed, an operation making the social relationship with the thing of the parent may be performed using an operation making a friend with the parent through the Web site.

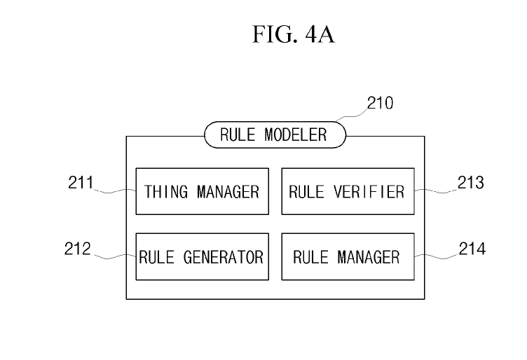

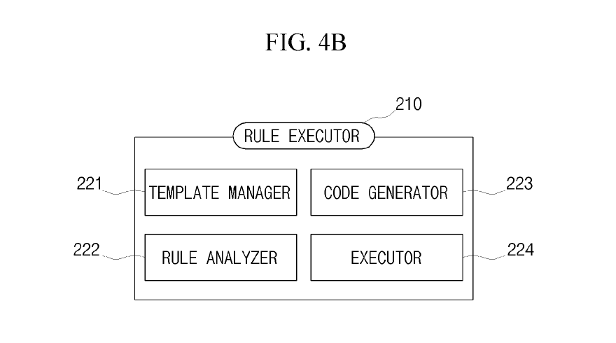

The rule modeler 210 may generate and verify the rule according to input through the graphic interface of the user. Here, the rule may be a simple text file, may not be executed by itself, and may need a programming code, etc. processing a business logic by associating with a rule execution engine which is executable the rule with the rule. Further, the programming code will be described with reference to FIG. 4B below.

Further, the rule modeler 210 may transmit a thing control specification and the rule file to the rule executor 220.

The rule executor 220 may provide the user with an execution pattern which can be selected, input a setting value of the execution pattern according to the selection of the user, and generate a Java source code template according to the selected execution pattern.

Further, the rule executor 220 may generate a Java source code (.java file) for a WoT service using the rule file, the thing control specification, and the Java source code template of each of the selected execution patterns. Further, the rule executor 220 may generate a byte code (.class file) which can provide the thing cooperation service to the user by compiling the rule file and the Java source code.

The rule executor 220 may access the thing by calling the REST API according to the rule be executing the WoT application according to the execution pattern at a time defined in the rule, and provide the user customized thing cooperation service by performing the operation of controlling the thing, etc.

When a status change or an event of the thing is generated while providing the thing cooperation service, the WoT application may store the changed status information and the event information in the database (DB) (not shown). After this, the WoT application or another application may check the changed thing status information or the event information from the DB.

Further, the WoT application may be ended at an end time of a life cycle which is automatically generated by the rule executor 220 or an end time defined by the user.

Meanwhile, detailed configurations of the rule modeler 210 and the rule executor 220 will be described with reference to FIGS. 4A and 4B.

Accordingly, an embodiment of the present invention may easily control not only a visual thing which is in the social relationship with each user but also a thing on the Internet which is not visible.

Further, an embodiment of the present invention may provide the graphic interface inducing the generation of the application for the user customized thing cooperation service, and support an amateur so that he or she easily uses the thing cooperation service that he or she wants by the input through the graphic interface.

Hereinafter, the rule modeler and the rule executor according to an embodiment of the present invention will be described with reference to FIGS. 4A and 4B.

FIG. 4A is a diagram illustrating a rule modeler according to an embodiment of the present invention.

As shown in FIG. 4A, the rule modeler 210 may include a thing manager 211, a rule generator 212, a rule verifier 213, and a rule manager 214.

The rule manager 214 may collect the thing list which is in the social relationship with the user and the thing control specification from the thing storage unit 100 according to the instruction of the user which desires to use the thing cooperation service.

For example, the thing manager 211 may confirm user information of the user related to the social network, and transmit the network information including information of the users which are in the social relationship with the user to the thing storage unit 100. And then, the thing storage unit 100 may search for a thing which is in the social relationship with the user according to the network information among the things in which the thing storage unit 100 manages, and transmit the thing list and the thing control specification with respect to the found thing. Further, the thing manager 211 may receive the thing list and the thing control specification from the thing storage unit 100.

Here, the user information may be information related to the social network such as an ID, or a company of the user of the thing cooperation service, etc., and the network information may be information of means which can search for a thing which is in the social relationship with the user such as a name of a thing and a name of a friend which is in the social relationship with the user, an ID of a specific site, etc.

The thing manager 211 may recognize input and output parameters, and a type which are needed for making the rule using the thing control specification, and generate a Java skeleton file for providing to the rule verifier 213 using the recognized fact.

The rule generator 212 may present a portion of the collected thing list and thing control specification, and provide the graphic interface for making the rule. For example, the graphic interface may include a first menu which can select each thing in the thing list which is in the social relationship, a second menu which can select a desired function among the functions of each thing, and a third menu which can select a condition (for example, a time) executing the desired function. A detailed example of the graphic interface will be described with reference to FIGS. 5A to 5D hereinafter.

The rule generator 212 may generate the rule file of a text type based on content of the input through the graphic interface. Here, the rule file may be a text file of a type which can be executed by the Java application having a type of “when condition then control”. Further, a time executing “control”, etc. may be included in “condition”, and a thing access, a control rule, etc. may be included in “control”.

In other words, when the user selects a thing which desires to perform control through the graphic interface, a control condition, and a function, etc., the rule generator 212 may generate the rule file using the selected content.

The rule verifier 213 may verify syntax of the rule input by the user through the graphic interface while being associated with the rule generator 212 in real time in the process of generating the rule file.

The rule verifier 213 may verify semantics of the rule generated in the process of or after generating the rule file, and provide information informing the user of generation of an error such as whether coherence and incompatibility of the rule occur.

Further, the rule verifier 213 may determine whether there is abnormal when executing the rule file generated using the Java Skeleton file generated by the thing manager 211. At this time, the rule verifier 213 may not perform the Web call for access and control of an actual thing, and determine whether it is possible to normally perform the defined rule file in the actual execution process by confirming the result according to the input and output parameters and the type.

The rule verifier 213 may provide the verification result of the rule file, for example, whether there is a grammatical error or whether the rule file is abnormal, to the user. At this time, when the user confirms the grammatical error or that the rule file is abnormal, the rule file in which there is no error or which is not abnormal may be generated again by manipulating the graphic interface again.

The rule manager 214 may perform a function such as storage, sharing, distribution, etc. of the rule for reuse and edit of the rule. More particularly, the rule manager 214 may store the generated rule file and share the generated rule with another user and distribute the generated rule file to another user, or after this, provide the generated rule file to other user which desires control similar to the above description.

FIG. 4B is a diagram illustrating a rule executor according to an embodiment of the present invention.

As shown in FIG. 4B, the rule executor 220 may include a template manager 221, a rule analyzer 222, a code generator 223, and an executor 224.

The template manager 221 may store the Java source code template according to each execution pattern of the WoT application, and receive a setting value thereof. Here, the Java source code template for each execution pattern may have a Java code skeleton for each execution pattern, and may include codes for object individualization, binding, management (start/monitoring/end) of a life cycle for each execution pattern.

Here, the execution pattern may include pull, push, polling, asynchronous call, etc.

As an example, when the execution pattern is a polling method, the WoT application may compare whether an event of the rule defined by the user occurs by periodically collecting information of the thing. In this case, the template manager 221 may input by requesting setting values of the execution pattern such as a thing information collection period, the number of retries when failing in information collection, a reception standby time after an information request, etc. which are a setting value of the Java source code template of the polling method.

As another example, when the execution pattern is a push method, since the Java source code for the WoT service should be generated as a different type, the template manager 221 may input the setting value according to the push method based on the manipulation of the user. As such, an embodiment of the present invention may previously store the source code template according to each execution pattern, and easily generate the Java source code for each thing by inputting only the input setting value of the user, etc. according to each execution pattern.

The rule analyzer 222 may parse a rule file, and generate a basic Java source code (.java file) including an attribute of a thing (Attribute) and a method (Method) which are used by the WoT application. Here, the rule analyzer 222 may determine a class name and an object name from the thing attribute specification of each thing, and generate a method file and a REST API call code through the thing attribute specification of each thing. At this time, a plurality of the basic Java source codes for each thing may be included.

The code generator 223 may receive the basic Java source code from the rule analyzer 222 and the Java source code template according to the previously selected execution pattern from the template manager 221, and generate the Java source code (.java file) for the WoT service performing at least one among the individualization, the binding, the REST API calling and the monitoring of the thing of the basic Java source code. Here, the Java source code for the WoT service may include a module for at least one among the management (start, end) of the life cycle of the WoT application, the thing individualization, the binding, the REST calling, the thing status monitoring, and the update of the WoT application.

The executor 224 may compile the Java source code for the WoT service, and generate the class file (.class file, it may be referred to as “byte code”).

The executor 224 may execute the WoT application on the rule execution engine according to the execution pattern using the class file at a time defined in the rule, access the thing by calling the REST API according to the rule, and provide the user customized thing cooperation service by performing the operation of controlling the thing, etc.

Further, the executor 224 may end the WoT application at the end time defined by the user or the end time which is automatically generated by the rule.

For example, the executor 224 may end the WoT application at a time defined according to the execution pattern, a time in which the provision of a desired service is ended according to the execution of the rule, or a time in which the previously set execution day is passed, etc.

Accordingly, an embodiment of the present invention can support a complex cooperation service with respect to a thing in which the user possesses, and also provide thing sharing, thing cooperation, and a user friendly tangible thing curation service based on a human's social relationship.

Further, an embodiment of the present invention can support the cooperation service so as to easily develop and use the application for the user customized thing cooperation service through the graphic interface without programming capability of a developer level.

Hereinafter, a method of supporting the graphic interface according to an embodiment of the present invention will be described with reference to FIGS. 5A to 5D. FIGS. 5A to 5D are diagrams illustrating a graphic interface according to an embodiment of the present invention.

Referring to FIG. 5A, the graphic interface may include a thing tree area 52, a drawing area 56, a function selection area 53, a verification area 54, and a package information area 55.

The thing tree area 52 may represent the thing list which is in the social relationship in a tree form, and provide a selection function with respect to one in the thing list. More specifically, as shown in FIG. 5B, the thing name may be included in the highest tree of the thing list, the attribute and the function of each thing may be included in a lower tree of the thing list.

The drawing area 56 may be an interface space for making the rule of the user, and display a work flow of the rule including a symbol selected by the user among usable symbols 51 and its flow.

The function selection area 53 may provide interface inputting content of each symbol used in the drawing area 56.

The code verification area 54 may display a result of logically verifying the generated rule in the process of making the rule or after ending the making of the rule. For example, as shown in FIG. 5C, the generated rule and whether there is an error in the rule may be displayed in the code verification area 54.

Meanwhile, the graphic interface may further include a package information area 55. As shown in FIG. 5D, a plurality of rules configuring one rule file may be displayed in a tree form in the package information area 55. For example, one rule file may include the plurality of rules for each condition, and may include the plurality of rules for each thing.

Example of Operation of Displaying Graphic Interface

The user may request the cooperation service between things using the things which are in a specific social relationship by logging in a specific program in order to use the modeling tool according to an embodiment of the present invention. And then, the thing list which is in the specific social relationship with the user may be displayed in the thing tree area 52 of the graphic interface.

Continuously, the user may select a thing in the thing list which is in the specific social relationship, and when selecting a desired symbol among the usable symbols 51 one by one, the selected symbol may be displayed in the drawing area 56.

Further, an interface which can input content corresponding to the selected symbol may be displayed in the function selection area 53. For example, when a symbol having an oval shape is selected, an interface which is selectable whether to turn on or off the selected thing may be displayed in a lower portion of the function selection area 53.

Further, when the input of the content with respect to one symbol is ended, the error verification result of the rule with respect to one symbol may be displayed in the code verification area 54.

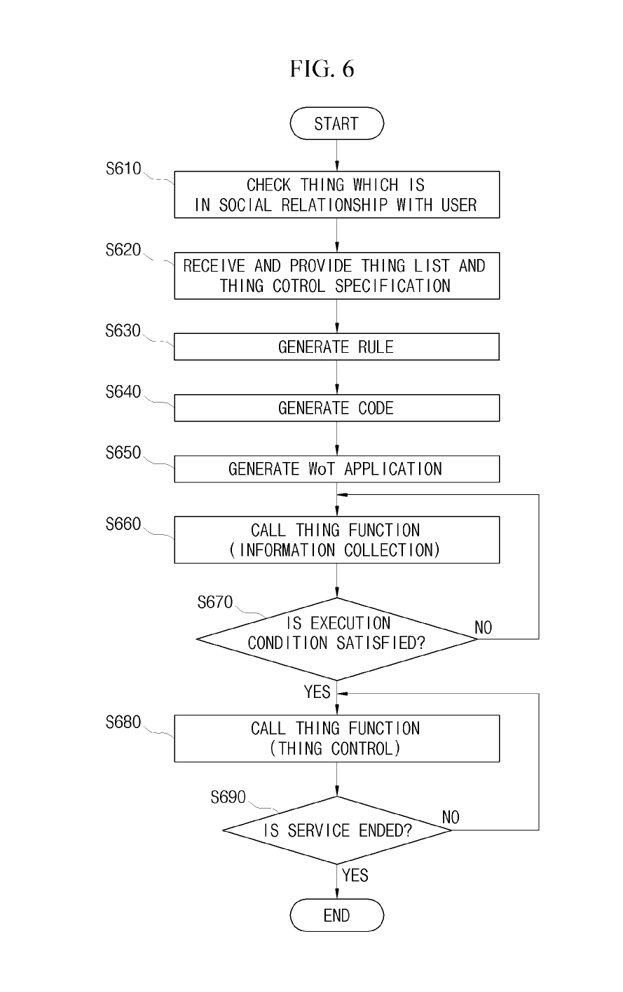

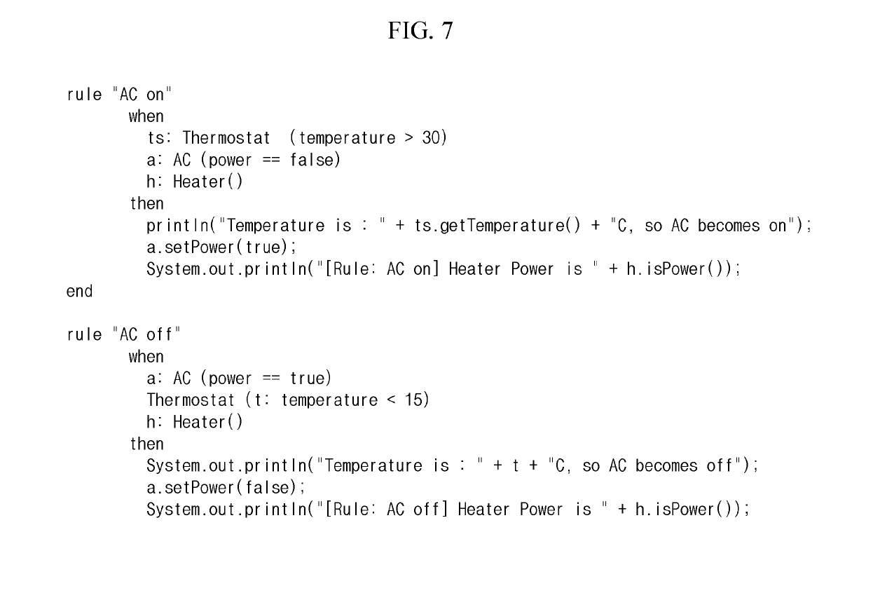

Hereinafter, a method of using a thing cooperation service according to an embodiment of the present invention will be described with reference to FIGS. 6 and 7. FIG. 6 is a flowchart for describing a method of using a cooperation service between things according to an embodiment of the present invention, and FIG. 7 is a diagram illustrating a rule file according to an embodiment of the present invention.

Referring to FIG. 6, the user may access the modeling tool 200 in order to receive the WoT service, and check the thing which is in the social relationship with himself from the thing storage unit 100 (S610). At this time, the user may selectively check the thing which is in the specific social relationship with him.

The modeling tool 200 may receive the thing list which is in the social relationship with the user and the thing control specification from the thing storage unit 100, and provide them to the thing storage unit 100 (S620). For example, the weather station and the messenger which are the things of the user, and the activity tracker and the coffee machine which are his friend's things may be included in the thing list.

And, the user may confirm information with respect to the weather station, the messenger, and the coffee machine, and confirm the thing control specification in the thing tree with respect to the thing list.

The user may manipulate the graphic interface according to a desired work flow, and make the rule file with respect to the thing which desires to use and the function (S630).

For example, when the outdoor temperature of the weather station is equal to more than 30 degrees Celsius and a walking distance of her or his friend is equal to or more than 5 Km (when), the work flow may be configured in a type sending a message recommending ice coffee using the messenger to her or his friend, and when her or his friend accepts the recommendation, controlling the coffee machine in order to make the coffee (then). The rule file according to the work flow described above may have a type shown in FIG. 7.

When the user ends the making of the rule through the graphic interface, the modeling tool 200 may automatically generate the Java source code for the WoT service using the generated rule file and the thing control specification with respect to the thing included in the generated rule file (S640), and execute the WoT application using the Java source code for the WoT service (S650). At this time, the modeling tool 200 may allow the user to select the execution pattern and further input the setting value of the Java source code template for each execution pattern, and generate the WoT application operating according to the selected execution pattern using the further input.

When the application is executed, the modeling tool 200 may call a thing function for information collection, and collect information from the thing (S660).

When the application is the WoT application corresponding to the work flow described in the operation S630, the modeling tool 200 may collect the outdoor temperature information (getOutdoorTemperature) from the weather station, and collect the friend's walking distance (getDistance) from the activity tracker possessed by the friend.

The WoT application may confirm whether a status of each thing is identical to the event execution condition which is previously set from the collected information (S670).

When the status of each thing is identical to the event execution condition which is previously set, the rule may be triggered, and the modeling tool 200 may call a thing function for the thing control, and control the thing using the thing function (S680).

For example, the WoT application may transmit a message to his friend through the messenger (SetMessage), and when confirming the acceptance of his friend, allow the coffee machine to make the coffee (setCoffeeType, setWater, setSugar).

Meanwhile, when it is confirmed that the status of each thing is not identical to the event execution condition which is previously set, the WoT application may continuously collect information until a time before an end time which is previously set.

After this, the WoT application may confirm whether to satisfy an execution end condition according to the rule file (S690), the WoT application may automatically end when satisfying the execution end condition.

According to the present invention, the WoT-based thing cooperation service can be provided.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. A thing cooperation service system comprising:
a storage manager configured to store and manage a thing control specification with respect to a plurality of things; and
a modeling tool configured to provide the user with a thing which is in a specific social relationship with a user in the plurality of things using information of the user and the thing control specification, and generate an application providing a thing cooperation service using a thing selected from things which are in the specific social relationship.

2. The thing cooperation service system of claim 1, wherein the user uses the thing cooperation service by connecting to the modeling tool through a mobile terminal.

3. The thing cooperation service system of claim 1, wherein the user manipulates an input and output interface of a computer in which the modeling tool is installed, and uses the modeling tool.

4. The thing cooperation service system of claim 1, wherein the storage manager searches for a thing which is in the specific social relationship with the user among the plurality of things using information with respect to the specific social relationship among pieces of information of the user, and provides the found thing to the modeling tool.

5. The thing cooperation service system of claim 1, wherein the modeling tool provides a graphic interface capable of inputting a control condition and a rule of the selected thing, and generates a rule file including a control condition and a control rule of the selected thing according to an input of the user through the graphic interface.

6. The thing cooperation service system of claim 1, wherein the modeling tool stores a Java source code template for each execution pattern, receives a setting value of the Java source code template corresponding to the execution pattern input from the user, and generates the application.

7. The thing cooperation service system of claim 1, wherein the modeling tool generates a method file and a representational state transfer (REST) application program interface (API) call code with respect to the selected thing performing access when executing the application using the thing control specification.

8. A modeling tool for a thing cooperation service, comprising:
a rule modeler configured to provide a graphic interface capable of receiving thing selection, a thing function, and a thing control condition, and generate a rule file based on an input of the graphic interface by a user; and
a rule executor configured to execute an application for a Web of things (WoT) service at a time according to the rule file using a thing control specification and the rule file of a thing selected through the graphic interface.

9. The modeling tool of claim 8, wherein the rule modeler receives a plurality of thing lists which are in a specific social relationship with the user and a thing control specification from a thing storage unit using information input by the user, and receives the thing selection, the thing function, and the thing control condition with respect to at least one thing in the plurality of thing lists through the graphic interface.

10. The modeling tool of claim 8, wherein the rule modeler verifies semantics of a control rule with respect to a thing selected through the graphic interface in the process of making the rule file or when ending the making of the rule file, and provides information on whether the control rule is erroneous.

11. The modeling tool of claim 10, wherein the rule modeler generates a Java skeleton file using the thing control specification of the selected thing, confirms a result according to input and output parameters and a type when executing the control rule using the Java skeleton file without a Web call with respect to the selected thing, and verifies whether the control rule is erroneous.

12. The modeling tool of claim 8, wherein the rule executor stores a template for each execution pattern of the application for the WoT service, receives a setting value of the template for each execution pattern input by the user, and generates a Java byte code for the WoT service using the setting value.

13. The modeling tool of claim 12, wherein the rule executor accesses the selected thing at a time according to the rule file, and executes the application using a byte code for the WoT service

14. The modeling tool of claim 12, wherein the rule executor generates a basic Java source code with respect to the selected thing from the thing control specification of the selected thing, generates a Java source code for the WoT service using the generated basic Java source code and the template for each execution pattern in which the setting value is input, and generates the Java byte code for the WoT service by compiling the Java source code for the WoT service.

15. The modeling tool of claim 8, wherein the rule executor ends the application at a time set according to the rule file.

16. A thing cooperation service method of a modeling tool, comprising:
receiving a thing list which is in a social relationship with a user, and a thing control specification;
receiving a selected thing in the thing list, a control condition, and a control rule through a graphic interface;
generating a rule file controlling the selected thing based on the rule input through the graphic interface; and
generating an application for a WoT service using the rule file.

17. The thing cooperation service method of claim 16, wherein the receiving of the thing list includes requesting a plurality of thing lists which are in a specific social relationship with the user and the thing control specification using information input by the user from a thing storage unit.

18. The thing cooperation service method of claim 16, wherein the generating of the rule file includes:
verifying semantics of a control rule with respect to the selected thing through the graphic interface at least one of while the rule file is generated or while the generating of the rule file has ended; and
providing information on whether the control rule or the rule file is erroneous according to the verifying of the semantics.

19. The thing cooperation service method of claim 16, wherein the generating of the application includes:
receiving a setting value of a template for each execution pattern input by the user in the template for each execution pattern of an application for a WoT service which has been stored; and
generating a Java byte code for the WoT service by further using the setting value of the template for each execution pattern.

20. The thing cooperation service method of claim 16, further comprising:
controlling each thing by connecting to each thing when a status of the thing according to the rule file satisfies an event execution condition which is set in the rule file; and
ending the application when the status of each thing according to the rule file satisfies an event end condition which is set in the rule file.
